(19) United States
(12) Patent Application Publication
(10) Pub. No.: US 2007/0146655 A1
(43) Pub. Date: Jun. 28, 2007

(54) Compact projection display with emissive imager

(76) Inventors: Zili Li, Barrington, IL (US); George T. Valliath, Winnetka, IL (US); Dongxue Wang, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/319,681

(22) Filed: Dec. 28, 2005

(51) Int. Cl. G03B 21/00

(52) U.S. Cl. 353/122

(57) ABSTRACT

The present invention provides a system for reducing the size of a projection display system. This is achieved by using an emissive imager that comprises a large number of emissive pixels. The emissive pixels provide both light output and light modulation functions. This eliminates the need for a separate illumination source. Each emissive pixel represents a pixel (or a sub-pixel for color projection) of an image to be projected. The light signals produced and modulated by the emissive imager are passed through a microlens array. The microlens array collects and reshapes the emitted light signals from the emissive pixels. Each microlens forms a light beam with a concentrated non-Lambertian radiation profile. The non-Lambertian radiation profile helps in effective collection of light at a projection lens. Finally, the projection lens collects this light and projects a magnified image on a projection screen.

### FIELD OF THE INVENTION

The present invention relates to projection display systems and particularly to compact projection display systems.

### BACKGROUND

Projection display systems have conventionally been used for displaying enlarged images in meetings, for entertainment purposes, personal and automotive applications, and the like. In recent years, the projection display systems have found a potential use in various other applications as well. There have been recent advancements in the field of handheld devices (such as mobile phones, PDAs, and the like), and an. increase in the bandwidth of communication networks. As a result, a number of image/video applications and Internet-surfing applications are becoming available on the handheld devices. However, the small-sized display screen, used in the handheld devices, remains a bottleneck for such applications. For example, a graphical HTML page or a high-resolution image/video cannot be properly displayed on these display screens due to their small size. Thus, in order to truly appreciate the quality of a high-resolution image/video, or to do an effective Internet surfing, the users would prefer a larger display that can be achieved by using projection display systems.

An existing projection display system, in general, comprises an imaging system and an illumination system. The imaging system comprises components for reflection or refraction of light, mixing light of different colors for color projection, imagers and a projection lens. The illumination system comprises an illumination source and components for focusing light from the illumination source on to the imaging system. Examples of illumination sources are tungsten-halogen lamps, high-density discharge (HID) lamps or solid-state lighting such as Light Emitting Diodes (LED) and lasers.

The imager is used for modulation of light, either through transmission or through reflection. The modulation of the light, emitted by the illumination system, is done according to the image information required for creating an image. Examples of the imagers used in the projection display systems are Liquid Crystal Display (LCD), Liquid Crystal on Silicon (LCOS) and Digital Micromirror Device (DMD). The projection lens projects the image formed by the imager onto a projection screen.

The existing projection display systems, as described above, suffer from a few drawbacks. These drawbacks make these projection display systems unsuitable for use with the handheld devices. Firstly, the projection display systems have a large weight and size making them difficult to handle. Secondly, the projection display systems have low illumination efficiency because of divergent light rays reflected/transmitted by the imagers. Less efficiency implies that greater amount of power is required at the illumination source for the same amount of brightness of the projected image. Lastly, the illumination sources consume a lot of power for a sufficient amount of brightness. Moreover, the design of high efficiency, high uniform illumination source is also not trivial.

Therefore, there is a need for a projection display system that is small in size and weight, is efficient in terms of power consumption and at the same time does not compromise on the brightness of the image being projected.

### SUMMARY

The present invention discloses a compact projection display system for projecting an image on a projection screen. The disclosed projection system is suitable for use with handheld devices in addition to other conventional applications. The disclosed projection display system comprises an emissive imager, a microlens array and a projection lens. A reduction in size and weight of the projection display system is achieved in the present invention by using an emissive imager. The use of the emissive imager eliminates the need for a separate illumination system that accounts for additional illumination lighting design and a substantial volume in conventional projection display systems. The emissive imager provides both light output and light modulation functions. The emissive imager emits light modulated according to the image information. The light emitted by each emissive pixel of the emissive imager is in a Lambertian profile. That is, the brightness of light is same in all directions, which implies low lighting collection efficiency due to a mismatch between a Lambertian light distribution of the emissive pixels of the emissive imager and the f-number of a projection lens. The f-number of the projection lens is the ratio of its focal length to its clear aperture. The lower the f-number, the better is the lighting collection efficiency. The f-number of common projection lens systems is about 2 to 3. To overcome the problem of low lighting collection efficiency, the light emitted by each pixel of the emissive imager is collected and reshaped by a corresponding microlens with a low f-number of about 0.6 in the microlens array. The microlens array is a two dimensional arrangement of a large number of microlenses. The number of microlenses is same as the number of emissive pixels in the emissive imager, wherein each microlens is matched to one emissive pixel. The microlens array reshapes the light emitted by each emissive pixel to non-Lambertian radiation profile with a narrow cone angle of light distribution, to match the f-number of the projection lens as accurately as possible. Thereafter, the projection lens magnifies the image on the emissive imager and projects it on a projection screen.

The present invention has several advantages. First, the invention eliminates the need for a separate illumination source in a projection display system by using an emissive imager. This substantially reduces the size and weight as well as the cost of the projection display system. Secondly, the microlens array, which is matched with the emissive imager at the pixel level, helps in achieving high lighting collection efficiency. This makes the projection display system power efficient as high amount of light, emitted by the emissive imager, is collected for projection. Thirdly, the microlens array can be fabricated and matched to the emissive imager using standard semiconductor processing techniques. This ease of fabrication also contributes to bringing down the overall cost of the projection display system.

### BRIEF DESCRIPTION OF THE DRAWINGS

The various embodiments of the invention will hereinafter be described in conjunction with the appended drawings provided to illustrate and not to limit the invention, wherein like designations denote like elements, and in which:

FIG. 1 illustrates a compact projection system for gray scale projection, according to an embodiment of the present invention; and

FIG. 2 illustrates a compact projection system for color projection, according to an embodiment of the present invention.

### DETAILED DESCRIPTION OF THE INVENTION

The present invention discloses a system for reducing the size of a projection display system. This is achieved by using an emissive imager (or a color emissive imager for color projection) that comprises a large number of emissive pixels (or emissive sub-pixels for color projection). The emissive imager provides both light output and light modulation functions. This eliminates the need for a separate illumination source, which includes additional illumination lighting design. The emissive imager produces light signals and modulates them according to information of an image to be projected. The emissive imager consists of a two-dimensional array of pixels (or sub-pixels for color projection). The light signals produced and modulated by the emissive imager are passed through a microlens array. The microlens array collects and reshapes the emitted light signals from the emissive imager for each emissive pixel. Each microlens forms a light beam with a concentrated radiation profile. The concentrated radiation profile helps in effective collection of light at a projection lens. Finally, the projection lens collects this light, magnifies the image, and projects the magnified image on a projection screen.

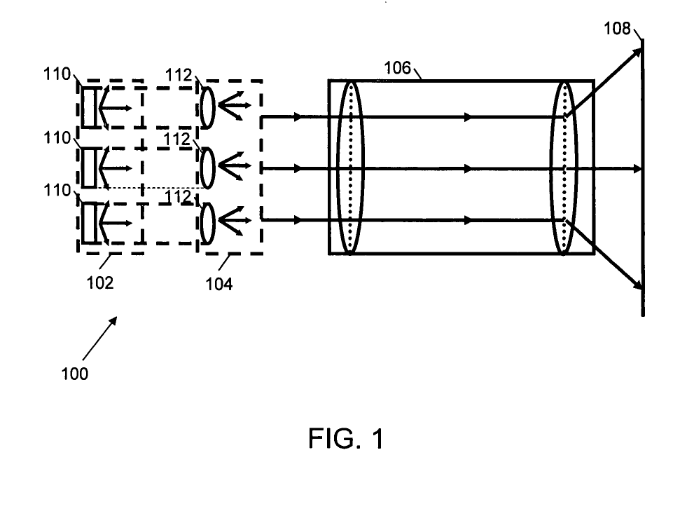

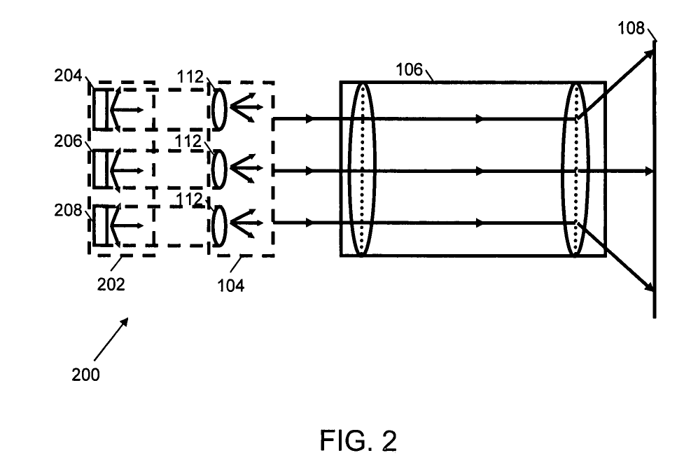

The disclosed projection display system can be used for both gray scale and color projection. The two cases have been described in conjunction with FIG. 1 and FIG. 2 respectively.

FIG. 1 illustrates a compact projection system 100 for gray scale projection, according to an embodiment of the present invention. Projection system 100 comprises an emissive imager 102, a microlens array 104, a projection lens system 106 and a projection screen 108. Emissive imager 102 is a collection of emissive pixels wherein each emissive pixel 110 represents a pixel of an image to be projected. Microlens array 104 is a collection of small lenses, each lens referred to as a microlens 112. Each microlens 112 is matched to one emissive pixel 110 to collect and reshape the light coming from that emissive pixel 110. The collected and reshaped light is made incident on projection lens system 106, which is used to magnify and project the image on to projection screen 108.

In FIG. 1, emissive imager 102 is shown to consist of only three emissive pixels 110. This is only for representative purposes. In practice, the number of emissive pixels 110 is much greater than that depicted in FIG. 1. The number of emissive pixels 110 equals the maximum number of pixels that can be used to form an image. Similarly, the number of microlenses 112 depicted in FIG. 1 is also representative. The actual number of microlenses 112 in microlens array 104 is the same as the number of pixels used to form the image. For example, the most commonly used formats for projections are VGA (640×480 pixels), SVGA (1024×780 pixels) or other higher resolution formats. In addition, for ease of representation, emissive imager 102 and microlens array 104 are shown separately at some distance. In practice, they are closely attached in the same substrate.

Emissive imager 102 performs both light output and light modulation functions. That is, emissive imager 102 emits its own light thereby eliminating the need for a separate illumination source used in conventional projection display systems. Further, emissive imager 102 modulates the emitted light according to image information.

Emissive pixels 110 known in the art (such as Organic Light Emitting Diodes) emit light in a Lambertian profile. Lambertian profile refers to a radiation profile in which the brightness of light is same in all directions. This increases the range of the angles from which the image can be viewed when used for direct-view displays. However, this is not desirable in the present invention, as the light emitted by emissive imager 102 is not viewed directly but is to be magnified for projection on to projection screen 108. Therefore, the light emitted from emissive imager 102 needs to be collected and reshaped to form a narrow beam of light to match the f-number of projection lens system 106. This is required for effective collection of light by projection lens system 106. The narrow beam of light, obtained because of the collection and reshaping of the emitted light performed by microlens 112, has a non-Lambertian radiation profile. Lighting collection efficiency is defined as the portion of optical power of light from emissive pixel 110 collected by the projection lens system 106. Microlens 112 narrows the cone angle of the light from emissive pixel 110 at emissive imager 102 to match the f-number of projection lens system 106 as close as possible. As a result, the lighting collection efficiency is improved by using microlens array 104.

For achieving high lighting collection efficiency, microlens array 104 is matched at the pixel level with emissive imager 102. That is, each emissive pixel 110 is matched to one microlens 112.

FIG. 2 illustrates a compact projection system for color projection according to an embodiment of the present invention. In this embodiment, projection system 200 comprises an emissive color imager 202, microlens array 104, projection lens system 106 and projection screen 108. Color emissive imager 202 forms color images instead of the gray scale images formed by emissive imager 102. Color emissive imager 202 is a collection of emissive pixels. Each emissive pixel consists of three sub-pixels, each corresponding to one of the three primary colors—red, blue and green. An emissive sub-pixel 204 emits blue light; an emissive sub-pixel 206 emits red light; and an emissive sub-pixel 208 emits green light. Three such sub-pixels form a set, such as an RGB triad similar to color formation in regular color TV that combines to form a single pixel of a color image to be projected. For better lighting collection efficiency, each emissive sub-pixel 204, 206 or 208 needs a corresponding microlens 112 such that the number of microlenses 112 in color projection is three times as compared to that in gray scale projection. The number of these sets of emissive imagers in emissive color imager 202 equals the number of pixels used to form the color image to be projected.

Each microlens 112 is matched to one emissive pixel 204, 206 or 208 so as to collect and reshape light coming from that emissive pixel. The collected and reshaped light is made incident on projection lens system 106, which is used to magnify and project the image on to projection screen 108.

In FIG. 2, emissive color imager 202 is shown to consist of only three. emissive sub-pixels 204, 206 and 208. This is only for representative purposes. In actual practice, the number of emissive sub-pixels 204, 206 and 208 is much greater than that depicted in FIG. 2. The number of emissive pixels of each primary color equals the number of pixels used to form the image. Similarly, the number of microlenses 112 depicted in FIG. 2 is representative. The actual number of microlenses 112 in microlens array 104 is the same as the number of emissive sub-pixels used to form the image. Further, for ease of representation, emissive color imager 202 and microlens array 104 are shown separately at some distance. In practice, they are closely attached in the same substrate.

Emissive color imager 202 performs both light output and light modulation functions. This eliminates the need for a separate illumination source used in conventional projection display systems. The light emitted by each of emissive sub-pixels 204, 206 and 208 represents a sub-pixel. Each emissive sub-pixel 204, 206 or 208 is controlled independently to modulate light according to the image information. In the case of color projection, the image information also includes the color information. For color projection, first, light modulated according to color information of each color is emitted by emissive sub-pixels 204, 206 and 208.

Emissive sub-pixels 204, 206 and 208 known in the art emit light in a Lambertian profile. As in the case of gray scale projection, such a profile is not desirable. This is because the light emitted from emissive sub-pixels 204, 206 and 208 is not viewed directly but is to be magnified for projection on to projection screen 108. Therefore, the light emitted from each of emissive sub-pixels 204, 206 and 208 needs to be collected and reshaped to form a narrow beam of light for high lighting collection efficiency to form a non-Lambertian radiation profile.

For achieving high lighting collection efficiency, microlens array 104 is matched at the pixel level with emissive color imager 202. That is, each emissive sub-pixel 204, 206 and 208 is matched to one microlens 112.

Examples of emissive pixels and sub-pixels 110, 204, 206 or 208, which can be used with the present invention, are Organic Light Emitting Diode (OLED), Polymer Light Emitting Diode (PLED), Light Emitting Polymer (LEP), and the like. Further, emissive pixels based on electroluminescent, field emission, vacuum fluorescent and other technologies can be used in the present invention. In addition to these, any other emissive imager based on other technologies can also be used.

Microlens array structures known in the art can be used in the present invention for microlens array 104. For example, A-spherical, piano-convex microlens using BK7 glass is designed to implement the light reshaping. In this microlens, the first surface is a plane and the second surface is an A-spherical surface (elliptical surface). The radius of the A-spherical surface is 5.06 mm, the conic constant is −0.59, the effective focal length is 9.8 mm and f-number is 0.65. The distance from emissive pixel 110 or emissive sub-pixel 204, 206 or 208 to microlens 112 is 0.5 mm. Finally, microlens array 104 can be fabricated as an integrated part of emissive imager 102 or emissive color imager 202 by standard semiconductor fabrication technology, such as photolithography and etching technology.

Projection system 100 described above can be assembled in various ways. Two of the methods are described below:

In one method emissive imager 102 and microlens array 104 are fabricated separately using standard semiconductor processing techniques. After emissive imager 102 and microlens array 104 are fabricated, microlens array 104 is attached to emissive imager 102 with a suitable Ultraviolet (UV) curable adhesive in between. An example of such an adhesive is Norland UV cured epoxy NOA65. Once each microlens 112 is matched with its corresponding emissive pixel 110 in the desired position, the position can be locked in through a UV radiation curing process.

In another method, emissive imager 102 and microlens array 104 are fabricated together. With this approach, the step of matching does not need to be performed separately.

The same methods, as described above, can be followed for assembling projection display systems for color projection as well.

Once microlens array 104 is matched to the corresponding imager (emissive imager 102 or emissive color imager 202) depending on gray scale or color projection, projection lens system 106 is placed in front of microlens array 104. Projection lens system 106 can be a suitable lens system known in the art having its collect cone matched to microlens array 104. For example, a standard double Gauss lens or a Cooke triplet can be used for this purpose. Both these types can offer a low f-number around two. Projection screen 108 is placed at a suitable distance from projection lens system 106.

The present invention when implemented in practice is able to achieve 4× gain in luminance level (lighting collection efficiency) for low aperture ratio of emissive pixel, and 2× gain in luminance level for large aperture ratio for a particular microlens design. Here, the aperture ratio is defined as the ratio of the actual area of a sub-pixel to the area of that sub-pixel that can transmit light. The microlens used here is an A-spherical, piano-convex microlens using BK7 glass. The first surface is a plane and the second surface is an A-spherical surface (elliptical surface). The radius of the A-spherical surface is 5.06 mm, the conic constant is −0.59, its effective focal length is 9.8 mm and f-number is 0.65. The distance from the emissive pixel (or emissive sub-pixel) to the microlens array is 0.5 mm. Using the microlens described above, the result is simulated using an optical retracing program. In this simulation, around one million optical rays are launched from one emissive pixel; and the optical power is collected by the projection lens system and detected by a detector. The detected power with and without the microlens is compared in order to determine the luminance level.

The present invention as described above has several advantages. First, the invention eliminates the need for a separate illumination source in a projection display system by using emissive imager (or emissive color imager). This substantially reduces the size and weight of the projection display system. This is because the illumination systems used in conventional projection display systems account for one-third to one-half of the total volume. Secondly, the microlens array, which is matched with the emissive pixels, helps to collect and reshape the light emitted by the emissive pixels to form a non-Lambertian radiation profile. This translates to high lighting collection efficiency. This makes the projection display system power efficient as large amount of light emitted by the emissive pixels is collected for projection. Thirdly, the microlens array can be fabricated and matched to the emissive pixels using standard semiconductor processing techniques. Ease of fabrication brings down the overall cost of the projection display system.

The above advantages make the projection display system small in size, lightweight, power-efficient, easy-to-handle and carry without being too costly. Such a projection display system is useful for all the applications where projection displays find use. Some of these applications are used for entertainment purposes, business meetings, automotive applications, and the like. In particular, the small size and weight, and high power efficiency enables the projection display system to be used as a portable module with handheld devices such as mobile phones, PDAs, etc. It is obvious to one skilled in the art that the disclosed projection display system may be integrated within a handheld device, or may be developed as an optional add-on module for a handheld device.

While various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A compact projection system for projecting an image on a projection screen, the projection system comprising:
an emissive imager, the emissive imager comprising a plurality of emissive pixels, each emissive pixel representing a single pixel of the image, the emissive pixel emitting light signals modulated according to the image information;
a microlens array, the microlens array comprising a plurality of microlenses, each microlens matched to one emissive pixel to collect and reshape the emitted light signals for high lighting collection efficiency; and
a projection lens system, the projection lens system having its collect cone matched to the microlens array to magnify and project the light signals collected by the microlenses on the projection screen.

2. The system as recited in claim 1 wherein the emissive pixel is an Organic Light Emitting Diode (OLED).

3. The system as recited in claim 1 wherein the emissive pixel is an electroluminescent device.

4. The system as recited in claim 1 wherein the emissive pixel is a field emission device.

5. The system as recited in claim 1 wherein each emissive pixel corresponds to one of the primary colors red, green and blue, the combination of three emissive pixels of the three primary colors representing a single color pixel of the image.

6. A compact projection system for projecting an image on a projection screen comprising:
an emissive color imager, the emissive color imager comprising a plurality of emissive sub-pixels, each emissive sub-pixel corresponding to one of the primary colors red, green and blue, the combination of three emissive sub-pixels of the three primary colors representing a single color pixel of the image, the emissive sub-pixels emitting light signals modulated according to the image information;
a microlens array, the microlens array comprising a plurality of microlenses, each microlens matched to one emissive sub-pixel to collect and reshape the emitted light signals for high lighting collection efficiency; and
a projection lens system, the projection lens system having its collect cone matched to the microlens array to magnify and project the light signals concentrated by the microlenses on the projection screen.

7. The system as recited in claim 6 wherein the emissive sub-pixel is an Organic Light Emitting Diode (OLED).

8. The system as recited in claim 6 wherein the emissive sub-pixel is an electroluminescent device.

9. The system as recited in claim 6 wherein the emissive sub-pixel is a field emission device.
